(19) United States
(12) Patent Application Publication
(10) Pub. No.: US 2013/0012242 A1
(43) Pub. Date: Jan. 10, 2013

(54) GEO-SPATIAL VISUALIZATION AND AWARENESS OF EVENTS

(76) Inventors: Swapan NAG, Claremont, CA (US); Monideep NAG, Laurel, MD (US); Swapan Nag, Claremont, CA (US)

(21) Appl. No.: 13/415,792

(22) Filed: Mar. 8, 2012

Related U.S. Application Data
(60) Provisional application No. 61/450,443, filed on Mar. 8, 2011.

(51) Int. Cl. H04W 64/00

(52) U.S. Cl. 455/457

(57) ABSTRACT

The present invention relates to geospatial visualization of events. A visualization platform may serve as a middleware system that provides real-time access to disparate hardware, software, and databases and provides visualization of data from these systems. The visualization platform may be accessed and utilized from a variety of mobile devices. Data may be fed from systems into the visualization platform via portals based on a data catalog interface. In other embodiments, the platform provides access to externally referenced documentation and visual resources and links this information with geographic resources. In other embodiments, a platform allows users to submit content related to an event and/or collaborate around an event. The content may be organized, such as by predefined or ad hoc categories, location, date, time, etc. In another embodiment, the present disclosure allows for a platform that integrates 3-D mapping with geo-referenced videos and images through a web interface.

### CROSS-REFERENCE TO RELATED APPLICATIONS

This application claims the benefit of priority of U.S. Provisional Application No. 61/450,443 filed Mar. 8, 2011, entitled “Geo-Spatial Visualization and Awareness of Events,” which is incorporated by reference in its entirety.

### FIELD

The embodiments relate to geospatial visualization of situational events.

### BACKGROUND

Geographic information systems (GIS) capture, store, analyze, manage, and present data linked to geographic locations. GIS may be used in a wide variety of applications and settings.

However, working with a GIS can cumbersome and difficult. For example, a GIS developed for an application, jurisdiction, enterprise, or purpose may not be necessarily interoperable or compatible with a GIS that has been developed for some other application, jurisdiction, enterprise, or purpose. In addition, known GIS have relatively few capabilities in working with the new generation of mobile devices, such as smart phones, tablets, GPS enabled devices, and the like.

Accordingly, it is desirable to provide a GIS that is capable of working across a variety of platforms and devices seamlessly.

### BRIEF DESCRIPTION OF THE DRAWINGS

The invention is explained in further detail, and by way of example, with reference to the accompanying drawings wherein:

FIG. 1 illustrates an exemplary system in accordance with the principles of the present invention;

FIG. 2 illustrates an exemplary architecture of an embodiment;

FIG. 3 illustrates an exemplary notification engine and reporting of suspicious activity of an embodiment;

FIG. 4 illustrates an exemplary architecture of application programming interfaces of an embodiment;

FIG. 5 illustrates an exemplary mobile application of an embodiment;

FIG. 6 illustrates an exemplary interface for reporting a package or other object for an embodiment;

FIG. 7 illustrates an exemplary interface for reporting a person for an embodiment;

FIG. 8 illustrates an exemplary interface showing a map and an icon indicating a location of a reported event for an embodiment;

FIG. 9 illustrates an exemplary set of data feeds that may be employed in an embodiment;

FIG. 10 illustrates an exemplary set of categories of data that may be employed in an embodiment;

FIG. 11 illustrates an exemplary interface for another embodiment;

FIG. 12 illustrates an exemplary process for creating an event in accordance with an embodiment;

FIG. 13 illustrates a display for another embodiment;

FIG. 14 illustrates flagging of various locations in accordance with an embodiment;

FIG. 15 illustrates an exemplary display of a stream view;

FIG. 16 illustrates an exemplary grouping of images and tagging in accordance with an embodiment;

FIG. 17 illustrate integration of topographic data in accordance with an embodiment;

FIG. 18 illustrates a functional grouping of data in accordance with an embodiment;

FIG. 19 illustrates tagging of a stream view for various users in accordance with an embodiment;

FIG. 20 illustrates a sharing of photos in accordance with an embodiment;

FIG. 21 illustrates a time slider feature in accordance with an embodiment;

FIGS. 22-23 illustrates integration of images from other sources in accordance with an embodiment;

FIG. 24 illustrates an exemplary bookmark list in accordance with an embodiment;

FIG. 25 illustrates an exemplary search feature as a pop-out portion of the display in accordance with an embodiment;

FIG. 26 illustrates an exemplary timeline feature shown in a display in accordance with an embodiment; and

FIG. 27 illustrates an exemplary image captured from a mobile device and shown with a display of an embodiment.

### SUMMARY

The present disclosure relates to geospatial visualization of situational events. In some embodiments, the visualization platform serves as a middleware system that provides real-time access to disparate hardware, software, and databases and provides visualization of data from these systems. The visualization platform may be accessed and utilized from a variety of mobile devices. In some embodiments, data may be fed from disparate systems into the visualization platform via secure and open portals based on a data catalog interface. The data catalog interface may further enable comprehensive search and results in multiple open formats and metadata. In other embodiments, the platform provides for access to externally referenced documentation and visual resources and links this information with geographic resources.

In other embodiments, the present disclosure provides a platform for multiple users to submit content related to an event and/or collaborate around an event. For example, the platform allows various users to report an event or provide content that enhances the situational awareness of the event. The content may be organized, such as by predefined or ad hoc categories, location, date, time, etc.

In yet other embodiments, the present disclosure allows for a platform that integrates 3-D mapping with georeferenced videos and images through a web interface. The objective of this concept is to develop a user interface to collect store, and map various types of photos and videos of streams and their surrounding riparian areas, taking into consideration current and future uses and their requirements, optimizing costs and interoperability.

### DESCRIPTION OF THE EMBODIMENTS

The present invention will now be described by illustrating certain embodiments. In a first embodiment, a geospatial intelligence platform is provided. In a second embodiment, a geospatial awareness platform is provided. In a third embodiment, a geospatial visualization and integration platform is provided. These embodiments are presented to illustrate the principles of the present invention. Those skilled in the art will recognize that other embodiments and contexts are possible. The accompanying drawings, which are incorporated in and constitute a part of this specification, illustrate several embodiments of the disclosure and together with the description, serve to explain the principles of the disclosure.

As noted, in a first embodiment, a geospatial platform is provided. For example, as shown, the geospatial platform may be configured to provide situational awareness, tactical intelligence, and strategic response.

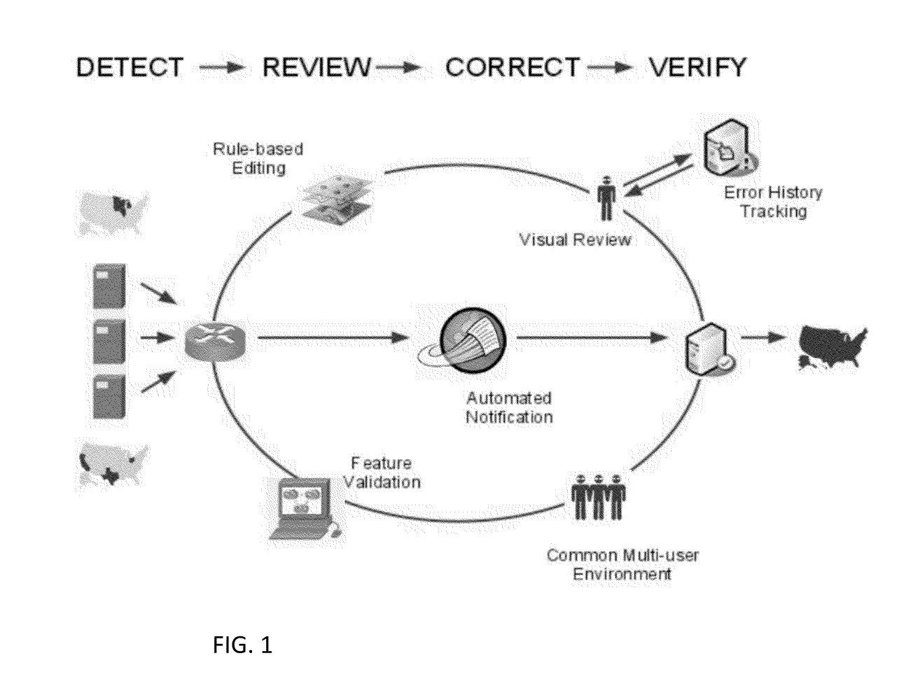

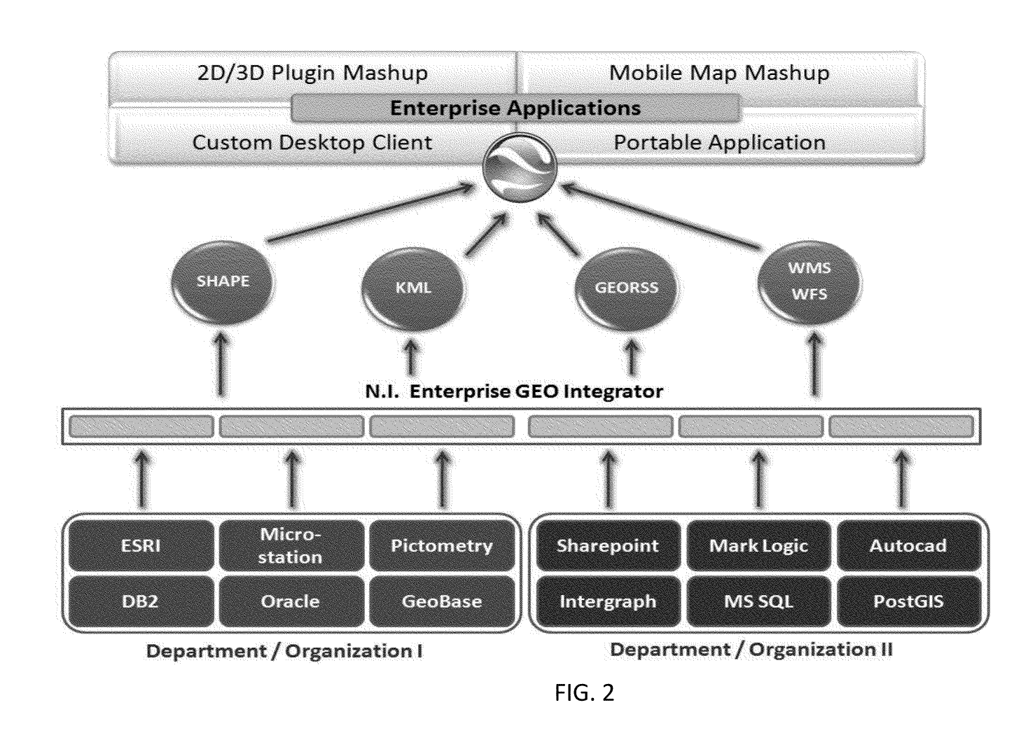

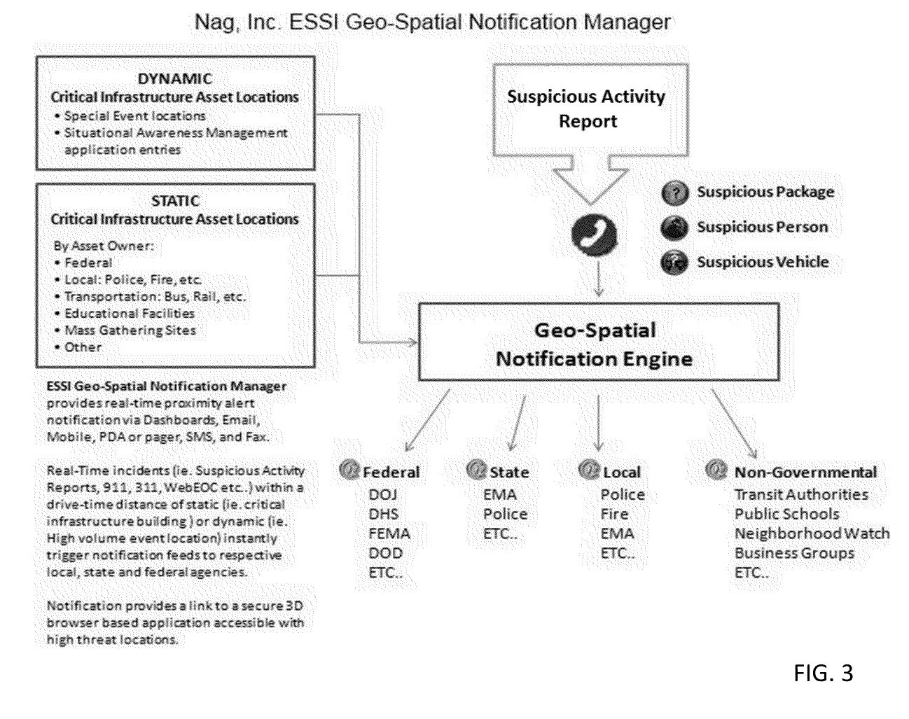

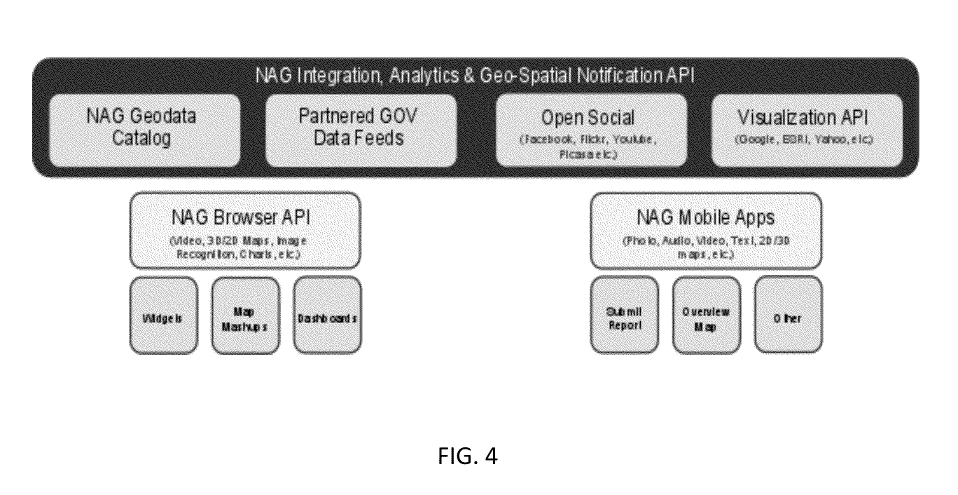

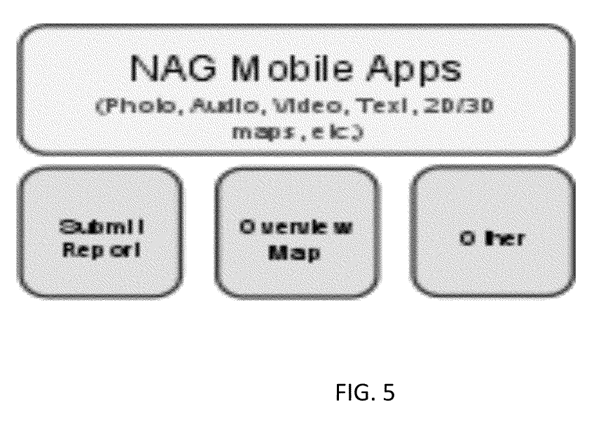

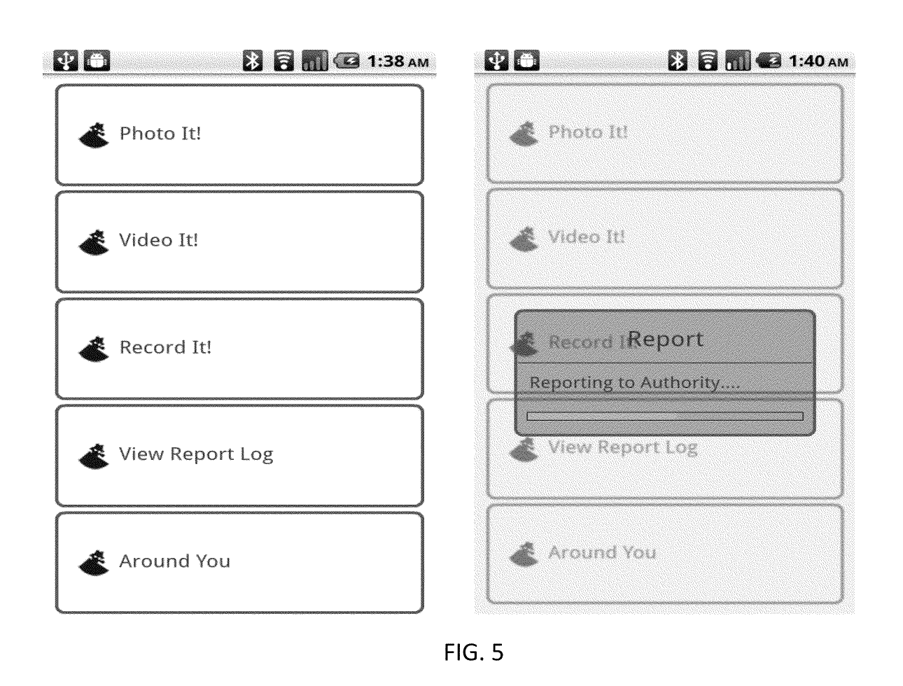

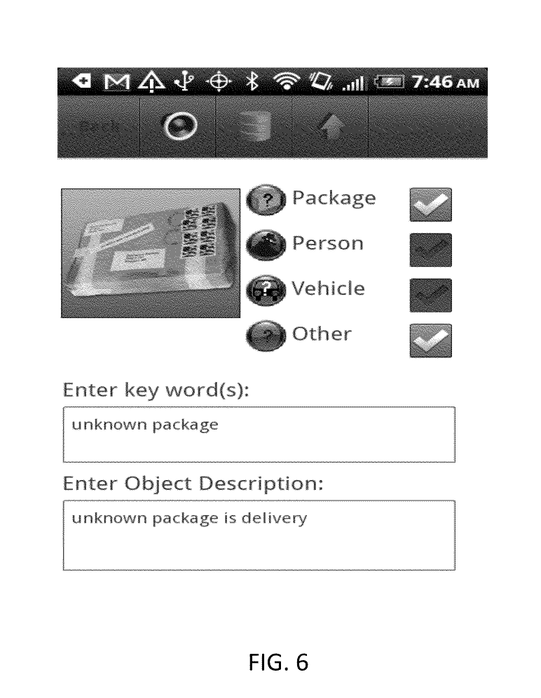

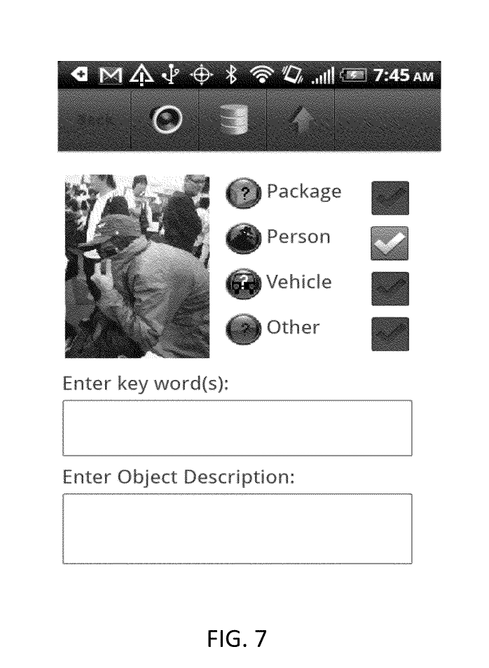

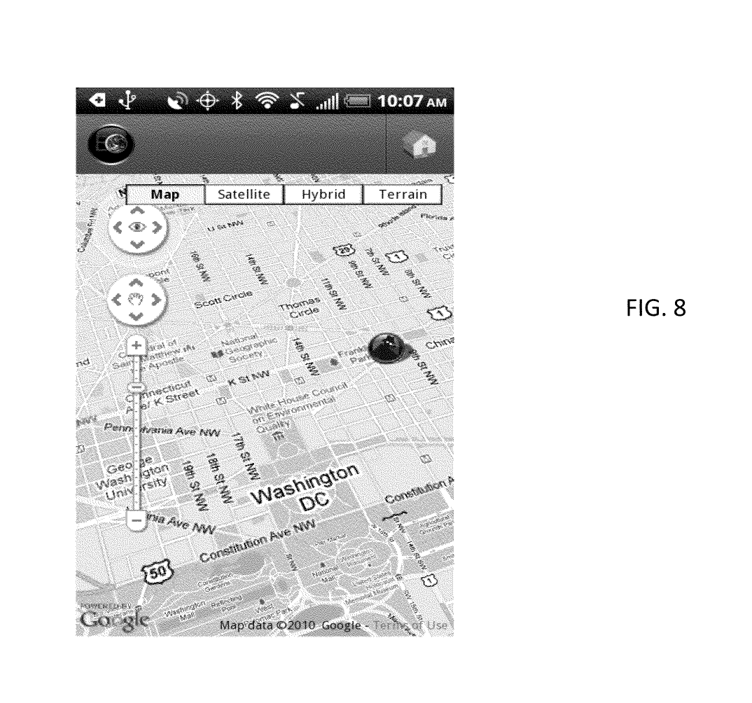

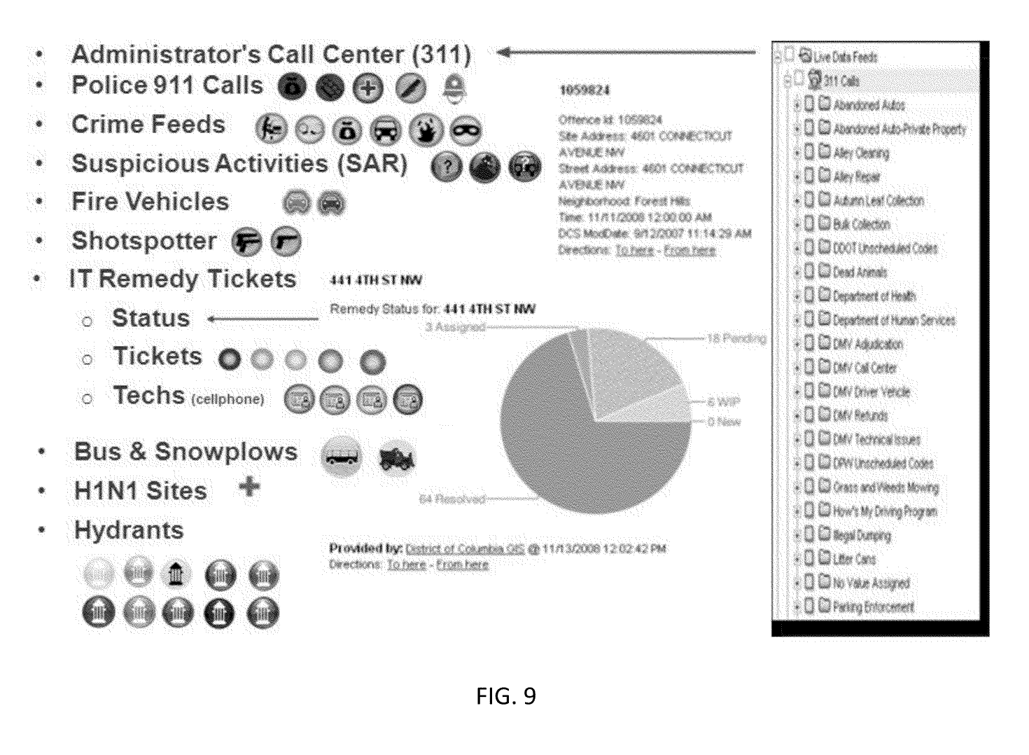

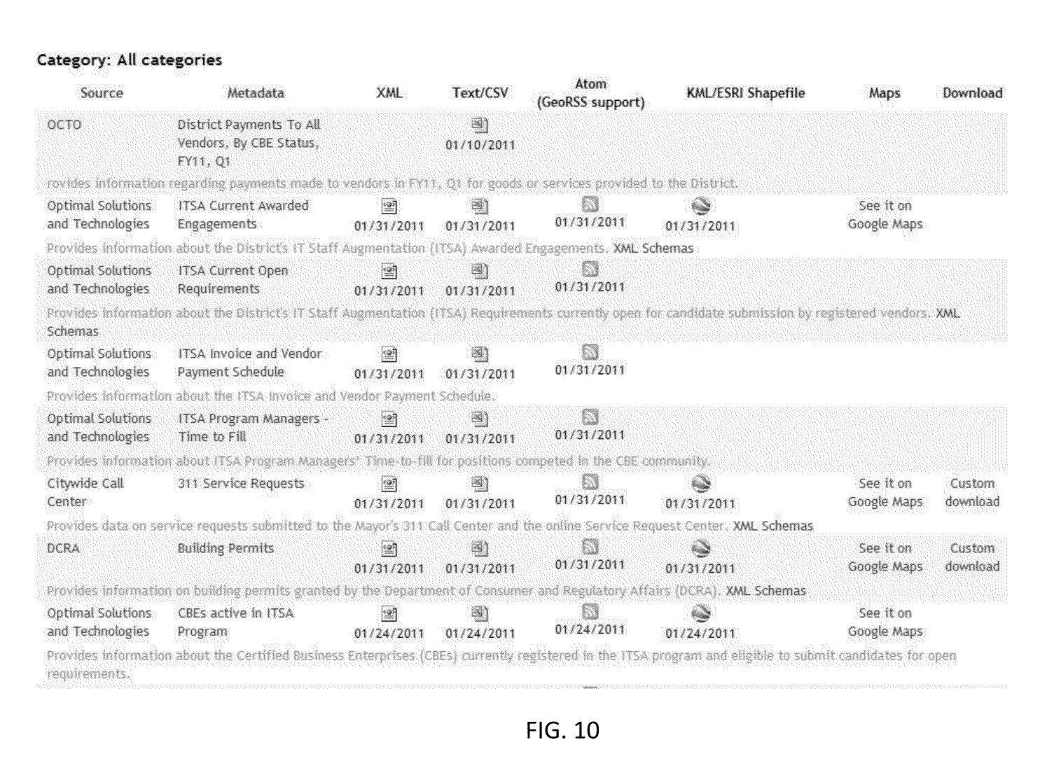

The situational awareness may accept a variety of GIS data feeds and maps, perform GPS asset tracking, enable crowd sourcing. As to tactical intelligence, the geospatial platform may be employed in an operations center to assist in communications, command, and control (C3) and provide tactical analysis and response. Moreover, the geospatial platform may be used for longer-term functions, such as strategic analysis, planning, and response strategy. FIGS. 1-11 show an exemplary product description.

The provide GIS and IT Solutions, products and services. The embodiment shown in Appendix A is an integration product, services and solutions provider, leveraging client investment in legacy and existing software platforms to produce a wide range of real-time Visualization Solutions on the Web, Desktop, Mobile, Large Screen Dashboard Display and Tablet.

The example shown in FIGS. 1-11 uses mash-up maps which feature backend OGC compatibilities and feeds such as Map Services, WMS, WFS, WCS, ArcGIS Server etc. For further speed performance and optimization of applications, the platform may be configured to reach directly into Oracle, MS Sequel and Informix databases to read, analyze and update geospatial information maintained by middleware software.

The platforms of the embodiments may utilize an intelligence platform that provides the umbrella middleware capability to access real-time the disparate hardware, software and database management applications from the entire range of federal, state, regional and local government agencies involved. Images may be shown for the visualization solutions where several hundreds to thousands of different datasets of information are displayed for diverse levels and divisions involved in projects.

The platform can be accessed and utilized from mobile devices. In one embodiment, an application has been created through which users are able to monitor, update, and contribute to the platform from their mobile devices such as ANDROID, IPHONE & BLACKBERRY.

In addition, the application may provide a Geo-Spatial Notification Manager provides real-time proximity alert notification via Dashboards, Email, Mobile, PDA or pager, SMS, and Fax. Threat notification instantly trigger feeds to respective local, state and federal agencies. Notification includes link to a secure 2D/3D maps.

Studies show that the top reasons for barriers to data sharing is that people are unaware of what information in other organizations. The embodiments simplifies this process by creating secure and open portals to distribute data, via the Data Catalog interface which provides a comprehensive search, with results in multiple open formats and metadata.

The platform is able to access multiple data formats (ESRI, GOOGLE KML, AutoDesk, Intergraph, Bentley, Oracle, SAS, SAP, MS SQL, etc.) utilized by the different resources being integrated into the target platform. Additionally, externally referenced documentation and visual resources are linked with geographic resources to produce a complete solution. The integration of various applications and types of data into a single visual platform facilitates situational awareness, tactical intelligence, and strategic response.

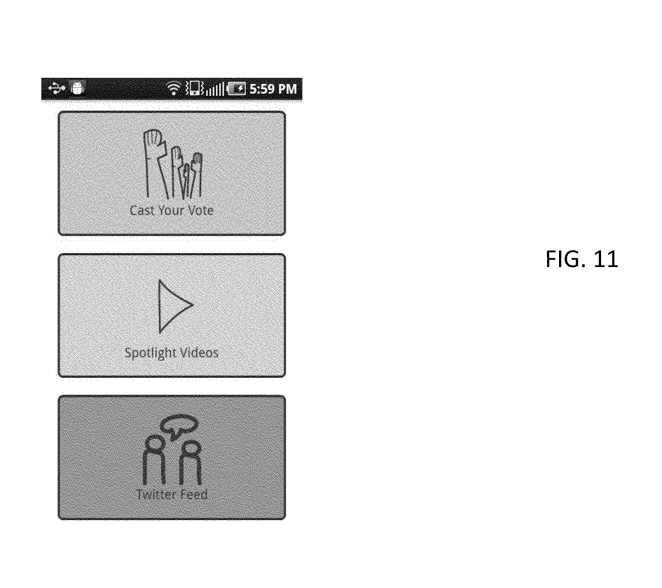

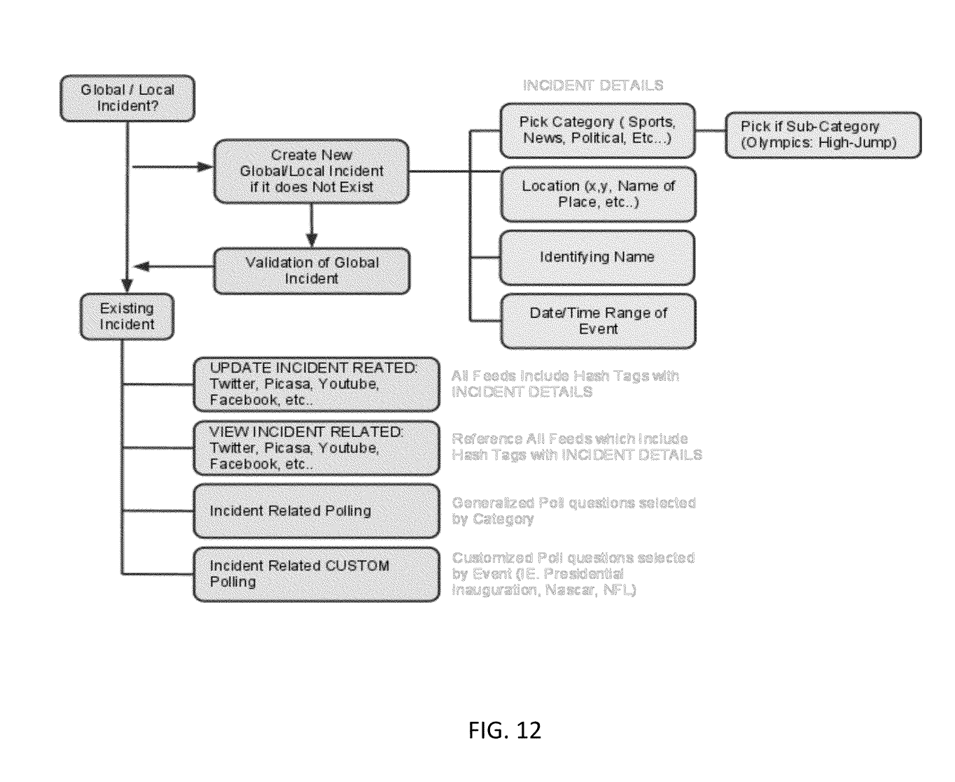

Referring now to the second embodiment for a geospatial awareness platform. In particular, a platform is provided for multiple users to submit content related to an event and/or collaborate around an event. For example, the platform allows various users to report an event or provide content that enhances the situational awareness of the event. The content may be organized, such as by predefined or ad hoc categories, location, date, time, etc. FIGS. 11-12 show an exemplary product description for a geospatial awareness platform that has been tentatively named “SpeakOut!,” for example.

In SpeakOut, the platform can provide the means to collect and build digital/locational representation of physical and infrastructural assets globally. Information gathered can be classified and organized to allow development of formal administrative management systems on local, regional, provencial and federal government systems. In one embodiment, the SpeakOut systems may allow monitoring of existing political and jurisdictional accountability and sustainability. Public events can be captured/nominated by individuals and supplemented by the public. The information gathered may be clustered by location to create auto-generated situational intelligence, scenarios for monitoring, and managing and responding to each live events.

As shown in FIG. 12, a login screen is shown. A login can be required when users create an event or update details about that event, for example, via twitter/youtube/picasa. An anonymous option may also be available. In one embodiment, the platform may support an Oauth login that can be integrated with google applications, twitter, facebook, etc. As is known to those skilled in the art, the oauth login is an open security standard which allows a login and interaction with multiple websites and applications.

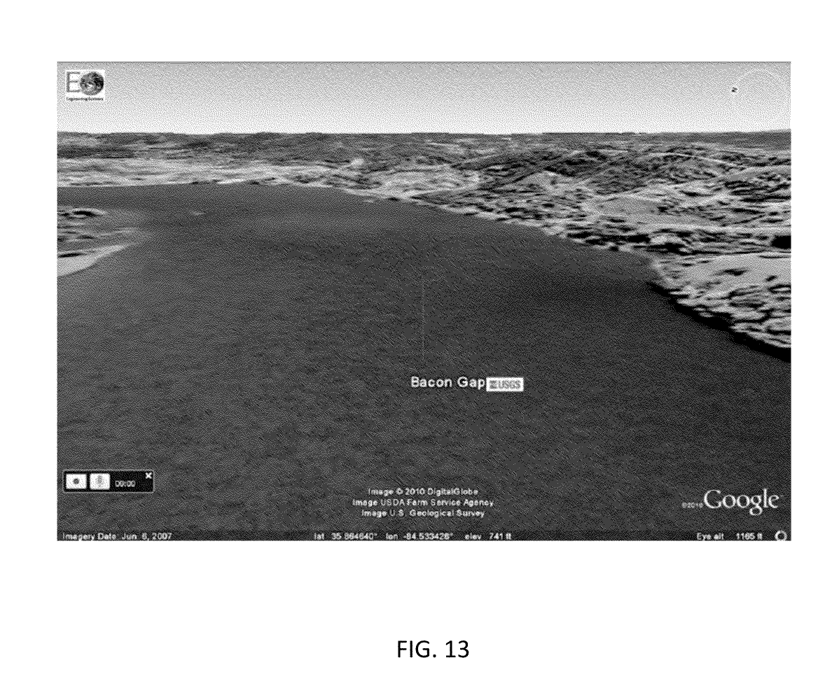

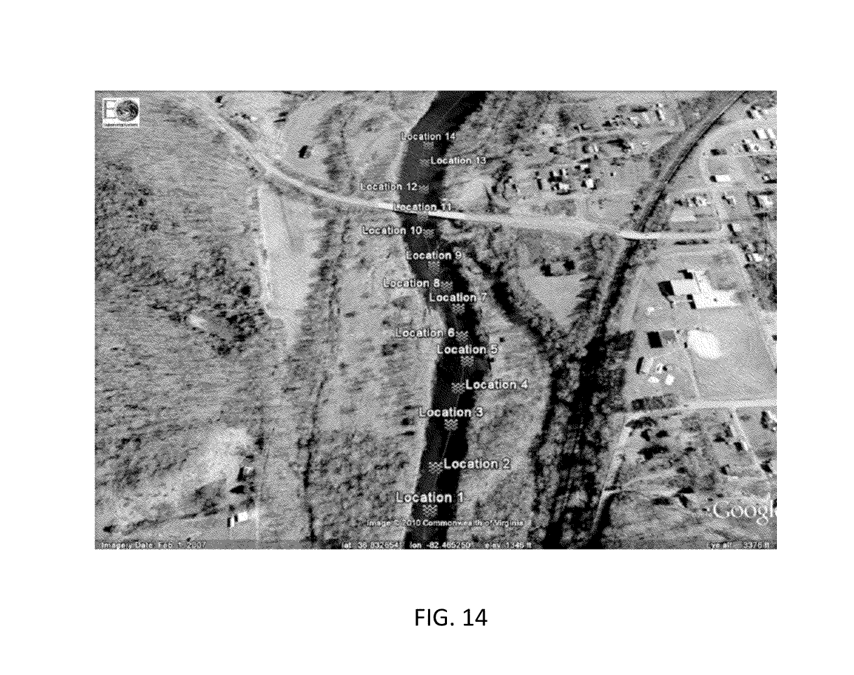

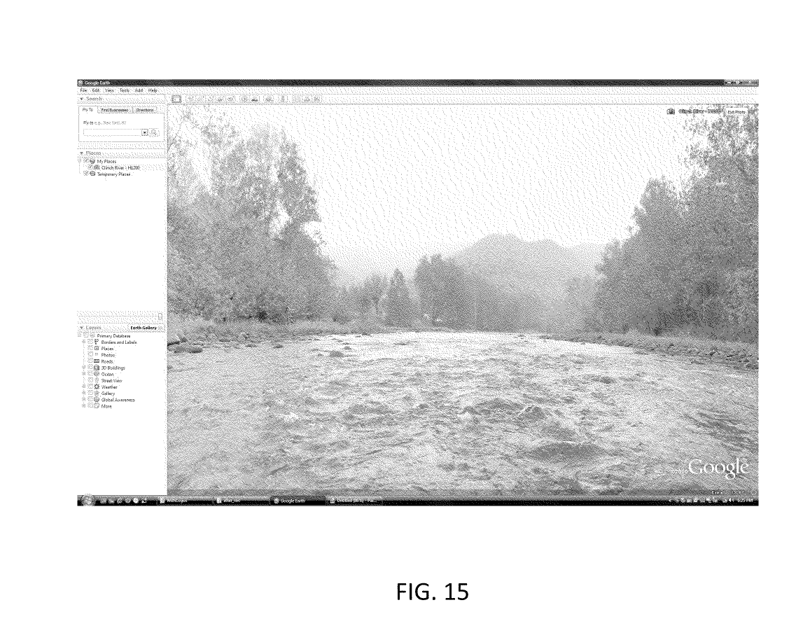

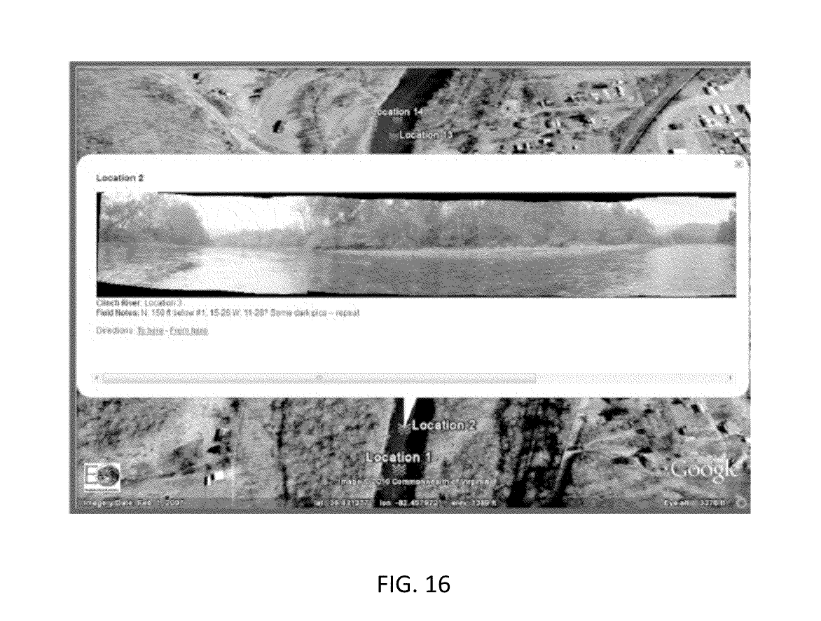

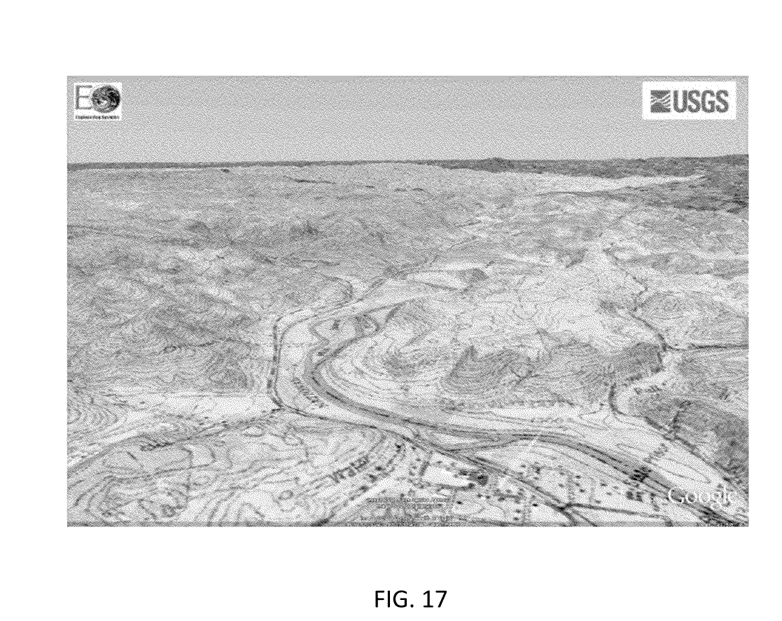

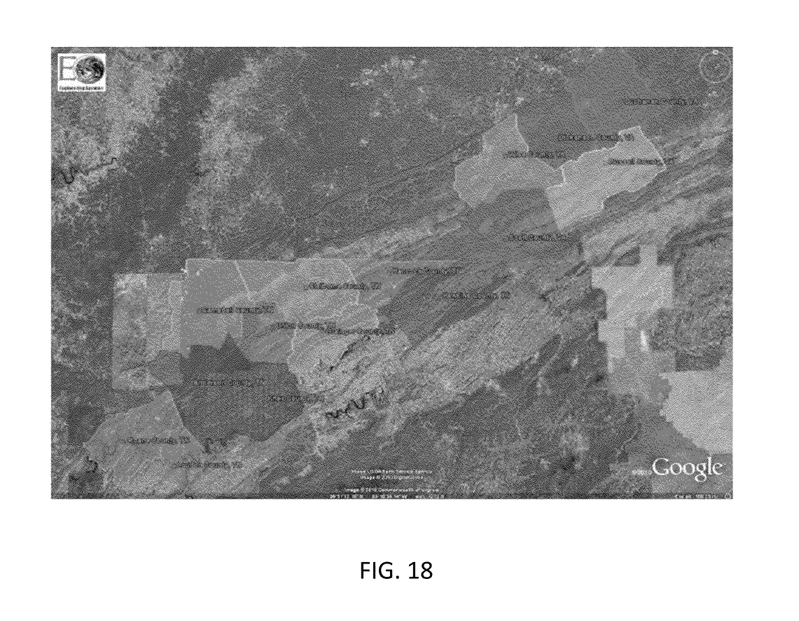

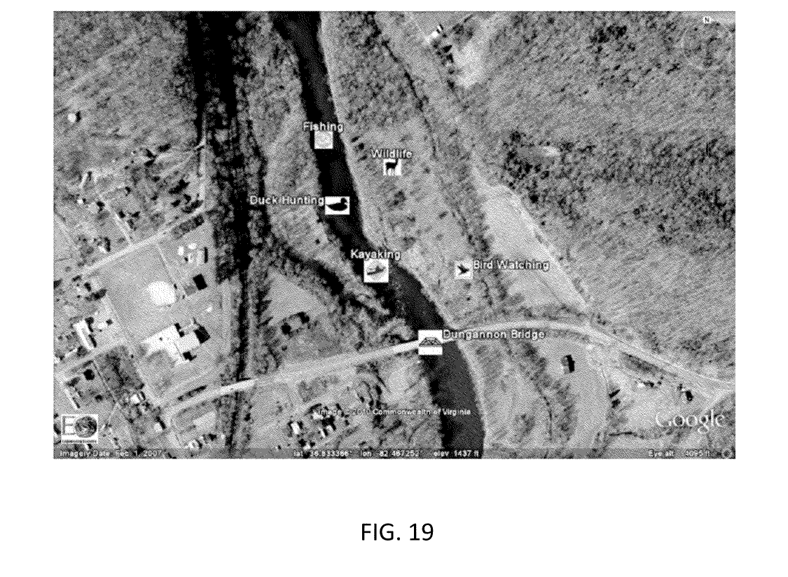

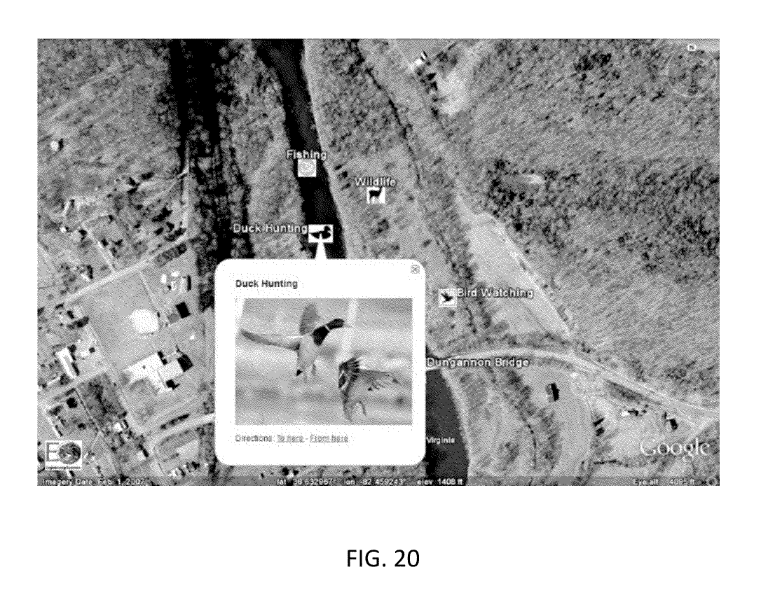

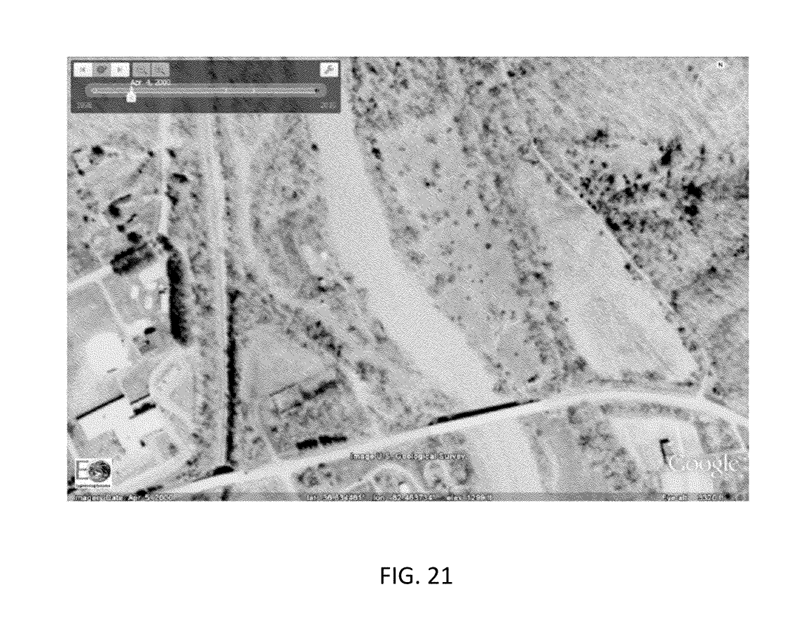

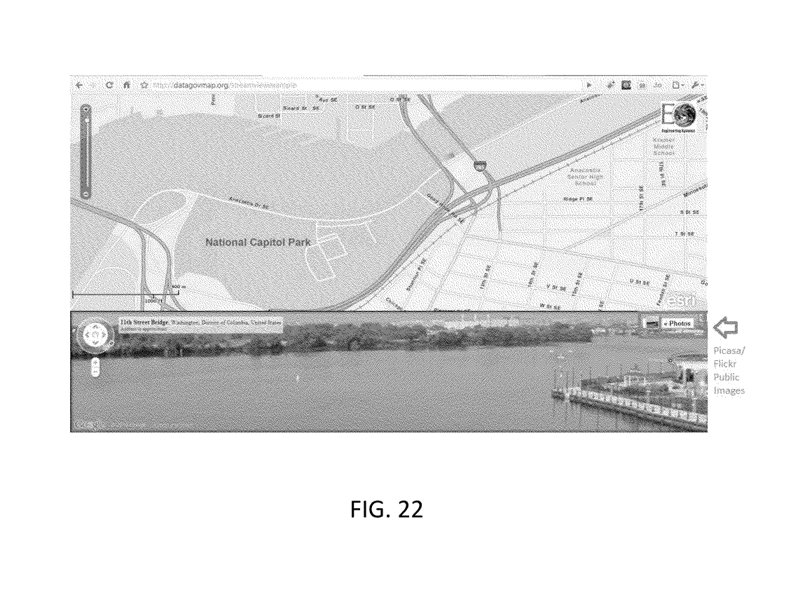

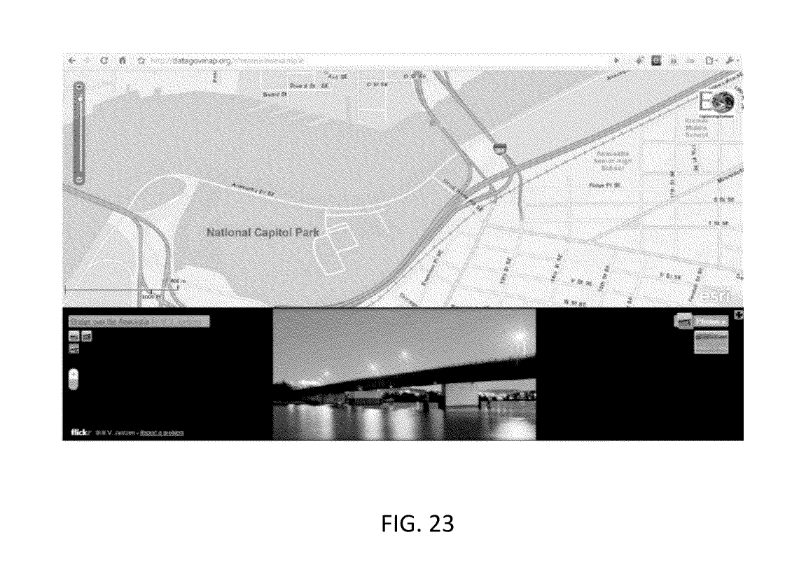

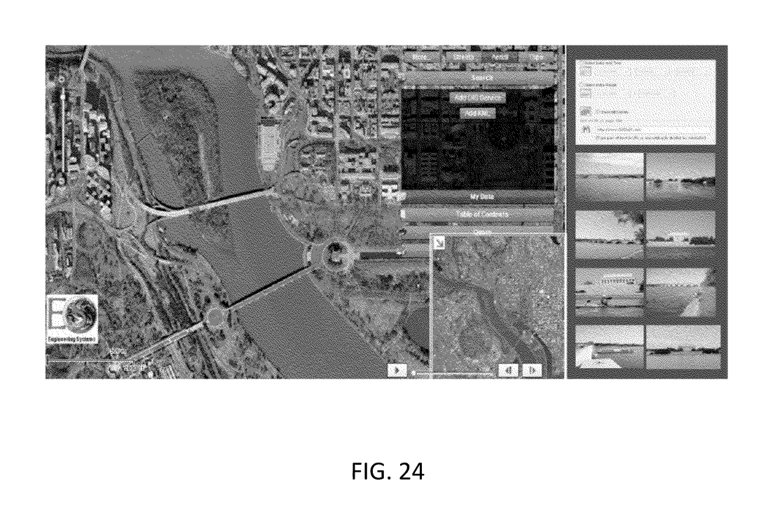

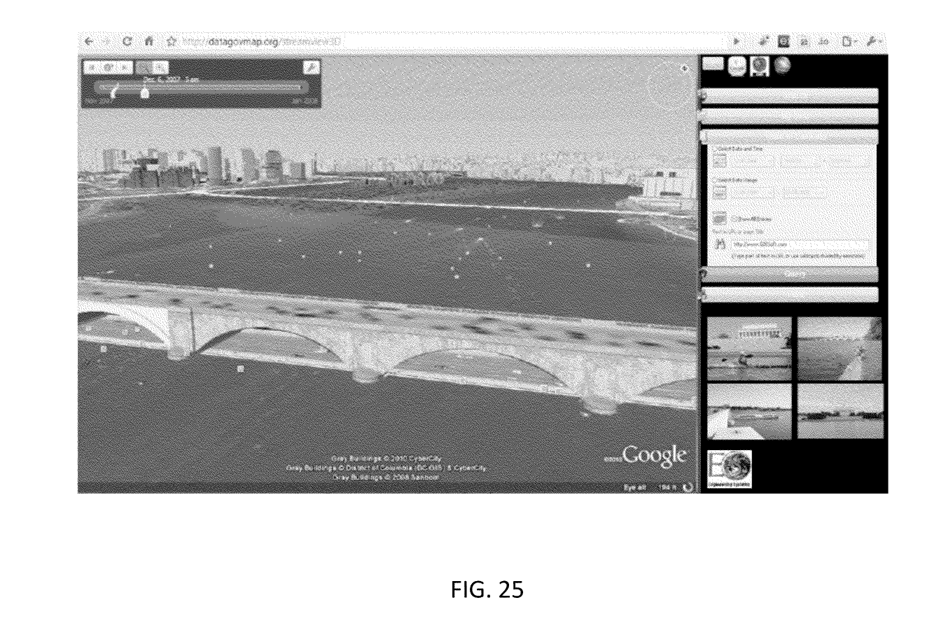

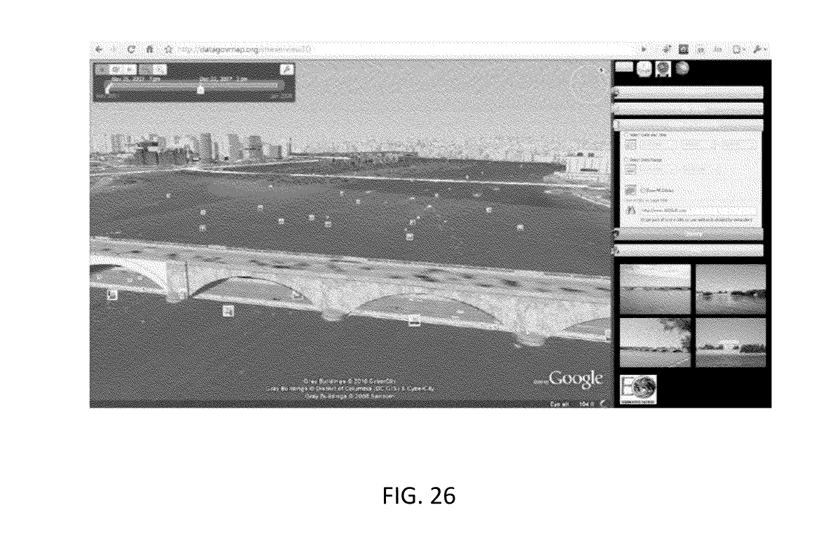

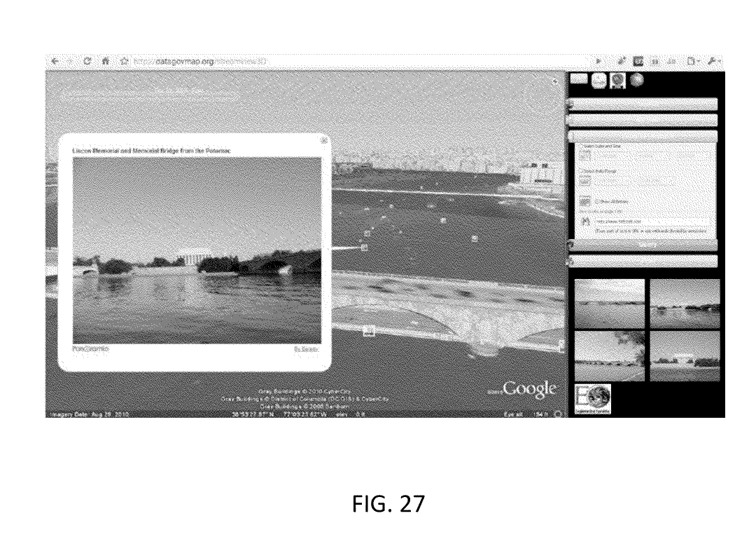

FIGS. 13-27 illustrate another embodiment of the present invention. As shown, in FIG. 13, a user may classify an event. When creating an event, the user may select a category (such as Sports/Entertainment/Politics/Organization/Subject, etc. and select whether the event is a global or local event. In addition, the user may be provided an option to create an event and shown a list of all events. Once an event is selected, various display options related to the event may be provided, such as Tweets with the event hash tag, a YouTube video's with the event keyword or hash tag, general questions about the event (standard for all events) and a comment box, a rating for this event (e.g., 1-5 stars), an indication of whether the user is attending this event, an indication of what is the favorite part of the event, and an option to allow users to tweet and upload upload photos and/or video on youtube about the event. For a local event, the SpeakOut platform may provide dates of upcoming local events near a user. The user may also be provided options to share a local event via email, social network, etc. A distance to the event may also be provided to the user by the SpeakOut platform. In one embodiment, a text based menu may list the category of events, such as social, charity, sports, entertainment, business, organization, by subject, sub-events with meet-up locations, demonstration walk, etc.

In one embodiment, un-structured data may be secured. A PIO may be stored for no more than 24 hours unless it is verified as a security threat. One or more heatmaps to show polling and activity results. In addition, a fuzzy location can be provided for anonymous updates.

In one embodiment, the user may be allowed to create their own event and submit it to the platform. In this embodiment, the form would ask questions, such as:

What type of Event?;

Local or Global Event?;

Is it a Sub-Event of a Global event?;

Upload an icon for the event or related images;

Custom Polls about the event;

Contact details about the user for internal use (optional);

Location of the event;

Time;

Twitter/YouTube Hash Tag/Keywords about event;

Links to purchasing tickets (if available);

A URL of the event (Facebook, eventbright, evite, CVENT); and

Whether the user wants to post the event on facebook/twitter/etc.

In one embodiment, users may be allowed to login from the Internet and create events and topics. Business and media organizations may also upload events and topics.

In one embodiment, every event can be broken down into parts. For example, an event like the Olympics includes different events at different times and different places. Another example could be meet-up events for a cause like a social gathering to campaign for a candidate. The user may classify the sub-event. In addition, the user may have a second hash-tag. After selecting an event, users may, for example, see updates related to the event; view submitted photos of the event; view tweets posted about the event; and view YouTube videos posted about the event. In addition, users may be able to update details about the event using a form to: categorize the update with a drop-down list showing a category of update, such as Happy/Sad/Warning; submit photos of the event; allow the users to tweet through the application about the event; upload to YouTube; etc. Moreover, every tweet/video/picture that gets uploaded may be uploaded using the keywords/hash tags provided by the event creator. The user may also specify a description for the content that the user is uploading.

There are several ways the embodiment may generate revenue related to events, such as Admob; providing data feeds about events to clients real-time for situational intelligence during emergencies; sell tickets to upcoming events at a discounted rate; fundraisers, and charge a business to create polling options for their offerings. The system may provide the polling updates back to them as a feed. Also as an option, the system may charge for a logo or coupon when they are nearby.

The embodiments may be implemented on all platforms, such as Android, Android, web, iPhone, blackberry, feature Phones (web-based UI with limited functionality). In addition, social site integration may be provided, for example, with Facebook, Twitter, YouTube, etc.

One embodiment provides an elastic network for spatio-temporal identity mapping integration. In this embodiment, a user-ID and login will ask users to submit background information about them to gauge their ability to be of assistance in emergencies. Thus, this embodiment provides an un-structured approach to identity. For example, at a location, a random group of people at a location may comprise: Sam the doctor was a volunteer Fireman, a volunteer with Doctors Without Borders, used to work the paper route and familiar with local roads; Jessica the engineer used to be a police officer, knows 3 languages and was a translator; Jeff the programmer Is a strong swimmer and used to be a substitute teacher at JAMES high-school and is very familiar with the environment. Thus, in a situation where the local JAMES high school has a shootout situation, with victims and hostages. An example of usage of the elastic network concept is when local law-enforcement officials will now have a new intelligent elastic network of individuals to pick from during emergencies.

In addition, the present invention can relate to a geospatial visualization and integration platform, an example of which will now be further described. A platform that integrates 3-D mapping with geo-referenced videos and images through a web interface. The objective of this concept is to develop a user interface to collect store, and map various types of photos and videos of streams and their surrounding riparian areas, taking into consideration current and future uses and their requirements, optimizing costs and interoperability. FIGS. 13-27 show an exemplary product description, tentatively called “StreamView”, of a geospatial visualization and integration platform.

The StreamView system can host a website and database of still photographs, 3D images, and videos. The embodiment comprises a user interface to collect, store, and map various types of photos and videos of streams and their surrounding riparian areas, taking into consideration their current and future uses and requirements, optimizing costs, and interoperability. For purposes of illustration, the images provided focus on photos taken along streams, the panoramic view is similar to Google's StreetView.

The StreamView embodiment is based on a stream record in which a set of panoramic still photos was taken about every 1200 feet down the approximate center-line of the channel. The photographer was on a small boat at successive anchor points or possibly even wading. These photo files were then converted into a panoramic ‘StreamView’ photo mosaic for the pilot. The pilot photo site was selected to: (a) be accessible within 1 hr or so of updates from a USGS office or small boat, (b) look attractive to the public for fishing, kayaking, and other recreational activities, and (c) feature relatively inaccessible locations so that someone from a big city near the pilot site who see the pilot stream view website.

This embodiment provides a web interface that will be maintained to serve as the foundation. In the particular implementation, the website is configured for inviting interest groups such as local watershed management agencies, and recreational groups such as associations affiliated with fishing, duck hunting, and birdwatching, etc. to participate in the integration of still images, videos, records and maps that will be registered to specific locations on the web-based map. Other data may be integrated, such as: web cam footage along streams, flow meter locations and data, digital maps and layers, geolocated and archived photos, scanned maps, all applicable terrain and stream data, and aerial photography. These data sets may be provided as data feeds so that the platform continuously update the website as the latest information becomes available.

The platform can reserve access to a restricted secure portion of the web application strictly for staff and their authorized contractors. This portion may contain data and records that will facilitate its internal use of the site. The platform may also provide a comprehensive set of GUI tools that will assist usage.

The embodiments allow data that resides on specific servers, but can also be made accessible to cloud applications, for example, through periodically updated data feeds, either URL, RSS, or XML based.

In FIGS. 13-27, images have been provided for a StreamView concept, for example, at the Clinch River, which runs through the greater part of Virginia. Potential users such as government agencies, researchers, academics, and outdoor enthusiasts can benefit from such virtual explorations of this river as StreamView would allow them to: Look into places to visit; Investigate anomalies and diagnose problems with streams; Quantify stream banks and riparian characteristics; Do visual comparisons of pool, riffle and run at various scales; Create physical models; and Learn about American history and exploration.

When viewing virtual representations of particular streams, scientists can flag locations where sampling was done and simultaneously access reference information at stream flow data sites. Recreational users can save favorite rivers, areas, and runs. They can also submit relevant information such as comments, trip reports, rare bird sightings, success of fishing trips, and links to additional websites.

As shown, the StreamView product can be displayed as a water-level image along the river, similar to Google map's StreetView along streets. StreamViews are 3D representations of panoramic photographs. These 3D views can be tagged with photos containing data for water condition, temperature, weather, and time of day. The images can then be grouped together and given a ‘recreational’ tag cluster to enhance search capabilities. Photo documentation projects and field scientists can also be easily visualized and tagged. A linked glossary can also provide access to helpful information such as hydrology and geology terms.

Public data, such as topographic maps can be used in conjunction with the high resolution Stream Views. The use of this data makes it easier to visualize stream channels, riparian areas, and weather conditions and effects.

Data can be grouped into functional layers that may be toggled on and off for comparison purposes.

StreamViews may facilitate community involvement through a number of ways. They enable the public to plan their trips by previewing the sites they intend to visit and also encourage grassroots action by allowing organizations to post announcements for cleanup days, calls for volunteers, and group trips. This, in turn, may motivate local groups to donate other resources and time to federal projects.

In addition, some users have some photos to share. These photos can be tagged and organized to communicate information in innovative ways such as: Geolocating photos by latitude, longitude, and stream address; Tagging photos with water condition, temperature, and weather; Displaying photos by time of day, date, or date range; Collecting and classifying photographs by category, i.e. kayaking, fishing, etc.; Creating personal photo collections using Panoramio, Flickr, or Picasa; and Cross fading photos to see vegetation growth over time

In addition to submitting photos, users can submit requests for streams or other types of features to be photographed. The platform can then view and evaluate the number of requests per stream and act accordingly.

Some benefits of tagging photos by time and date may include: Allowing the public access to historic USGS stream photos taken over last 140 years; Comparing changes over time and examining historical trends; Filtering images of frequently photographed areas; Studying variation throughout the seasons—spring, summer, fall, and winter; Viewing environmental modifications, such as a dam constructed in 1982 and erosion controls added in 1998; Taking inventory of geomorphic features in stream channels; Documenting erosion and sedimentation on banks and bars along streams; Providing a frame of reference about flooding issues and visualizing a “flood depth.”; and Documenting riparian habitat conditions and changes.

The embodiments described can perform all the functions previously shown and much more. In addition, the embodiments can mine existing sources like Google's Picasa, Yahoo's Flickr, and Twitter. Additionally, open community photos can be automatically indexed using an API. It is also possible to control security levels, data accessibility, and system privileges for different users.

As shown, an interface is provided through which users can attach their photographs to the web application. This example shows all the public and private image resources available in a specific location. The embodiments may also interface with partners, such as Flickr and Picasa for stream indexing to create a systematic way to archive photos taken during field visits.

The embodiments also allow users to attach notes and comments to pictures. As shown, a bookmark list of rivers and streams can be equipped. For example, clicking on a stream may present the user with 3 options:

1. An upstream or downstream tour of the stream/river.

2. Zoom to the bookmark area.

3. Provide miscellaneous details about the bookmarked area.

In addition, the embodiments allow mash-ups with other applications that are geographically tied to streams and provides links, for example, to federal agencies, local non-profit organizations, and other reference websites and publications.

Users are also able to access RSS feeds or Twitter announcements upon update. Feeds can be filtered for content using keywords like pollution, trash, or trip report. User communities can set their own keywords and receive a notification whenever someone posts a comment using the keywords. Links to YouTube videos for related information and news reports can also be provided.

In other embodiments, a pop-out version of the advanced search function allows for additional search capabilities of all geo-tagged images on the web. Search options provide image, tweets and other resources using, for example, the following parameters: Search by Date Range; Search by Date Range within an alloted time. (ie. October 2-October 23 between 1 pm-5 pm); Show all images from a specific URL or RSS feed; Show all images from a specific user/group/organization; Show all images from all images within a specific radius Show all images within screen area; and Show all image within a specified buffer of the stream.

The embodiments may provide a Date/Time slider that allows users to view individual public and private image resources in Picasa, Flickr, etc. for a specific time or date range. Various images of this feature are provided in Appendix C. New images may also show up on the bottom right corner. Furthermore, the application can also be viewed and utilized on mobile devices. Users can capture photos and videos and upload them for online viewing.

The foregoing merely illustrates the principles of the invention. It will thus be appreciated that those skilled in the art will be able to devise various arrangements which, although not explicitly described or shown herein, embody the principles of the invention and are thus within its spirit and scope. Other system configuration and optimization features will be evident to one of ordinary skill in the art in view of this disclosure, and are included within the scope of the following claims.

The features and attributes of the specific embodiments disclosed above may be combined in different ways to form additional embodiments, all of which fall within the scope of the present disclosure. Although the present disclosure provides certain embodiments and applications, other embodiments that are apparent to those of ordinary skill in the art, including embodiments, which do not provide all of the features and advantages set forth herein, are also within the scope of this disclosure. Accordingly, the scope of the present disclosure is intended to be defined only by reference to the appended claims.

What is claimed is:

1. A method visualizing an event on a geo-spatial display, said method comprising:
receiving, from a plurality of mobile devices, information related to an event;
determining a location for the event based on the received information; and
providing, to the plurality of mobile devices, visualization information for the event indicating categories of the information and locations of the categorized information for the event.
